(19) United States
(12) Patent Application Publication
(10) Pub. No.: US 2025/0219755 A1
(43) Pub. Date: Jul. 3, 2025

(54) APPARATUS AND METHOD FOR OPTICAL COMMUNICATION IN CODE-DIVISIONAL MULTIPLE ACCESS SCHEME USING DEEP LEARNING

(71) Applicant: KOOKMIN UNIVERSITY INDUSTRY ACADEMY COOPERATION FOUNDATION, Seoul (KR)

(72) Inventors: Yeong Min JANG, Seoul (KR); Ngoc Huy NGUYEN, Seoul (KR)

(21) Appl. No.: 19/004,104

(22) Filed: Dec. 27, 2024

(30) Foreign Application Priority Data
Dec. 29, 2023 (KR) 10-2023-0195888
Dec. 20, 2024 (KR) 10-2024-0192611

(51) Int. Cl. H04J 13/00; H04J 11/00; H04L 27/12

(52) U.S. Cl. CPC H04J 13/0077; H04J 11/00; H04J 13/0048; H04L 27/12; H04J 2011/0006; H04J 2011/0009

(57) ABSTRACT

An optical communication method using deep learning in a code-division multiple access (CDMA) scheme may include obtaining an image of an optical signal from a light source and applying a first model trained to identify a location of the light source to detect the light source in the image. The method may also include detecting a preamble of an on-off keying (OOK) modulated signal from a pulse signal generated based on the identified light source using a second model trained to detect preambles in received signals, to decode the OOK modulated signal for a first user device by applying a first pseudo-random noise (PN) code. The method may further include determining a start position of an orthogonal frequency division multiplexing (OFDM) frame in an OFDM modulated signal from the pulse signal, to decode the OFDM modulated signal by applying a first Walsh code.

### STATEMENT REGARDING KOREAN GOVERNMENT SUPPORT

This disclosure was supported at least in part by Ministry of Science and ICT of South Korean government for research project, the title of which is “Research on intelligent Internet of Energy (IoE) Data” managed by IITP (Institute of Information & Communications Technology Planning & Evaluation). The project code number is 1711193294.

This application claims benefit of priority to Korean Patent Application No. 10-2023-0195888 filed on Dec. 29, 2023, and Korean Patent Application No. 10-2024-0192611 filed on Dec. 20, 2024, in the Korean Intellectual Property Office, the entire disclosures of each of which are incorporated herein by reference.

### BACKGROUND

### Technical Field

The present disclosure relates to an optical communication apparatus and method utilizing deep learning in a code-division multiple access (CDMA) scheme.

### Background

The contents described below merely provide background information on embodiments of the present disclosure, and do not constitute prior art.

Recently, lamps such as incandescent light bulbs and fluorescent lamps have been replaced with semiconductor light emitting diode (LED) lamps. Visible light communication (VLC) technology, which is a wireless communication technology that adds a communication function to wavelengths of visible light emitted from the LED lamp, is being actively studied.

In Korean Patent Registration No. 10-165184 (registered on Aug. 22, 2016; hereinafter referred to as “related art 1”), disclosed is a technology for communicating with a camera-based M-FSK scheme that uses a rolling-shutter camera. However, a general M-FSK scheme has difficulty in transmitting high-speed data.

In Korean Patent Application Publication No. 10-2008-0064804 (published on Jul. 9, 2008; hereinafter referred to as “related art 2”), disclosed is a digital optical signal transmission technology in which information bits are mapped based on FSK and then the mapped signal is again multiplexed based on OFDM. However, related art 2 has a limitation of FSK-modulating only the same information, rather than different types of information, and then multiplexing the modulated information with OFDM.

### SUMMARY

Embodiments of the present disclosure are directed to providing a technology capable of simultaneously transmitting or receiving high-speed data and low-speed data in visible light communication (VLC).

Embodiments of the present disclosure are further directed to providing a technology capable of simultaneously transmitting or receiving different types of data by using a pulse wave signal modulated based on visible light communication technology, and an OFDM modulated signal.

The present disclosure is not limited to what has been mentioned above, and other objects and advantages of the present disclosure that are not mentioned may be understood by the following description, and will be more clearly understood by the embodiments of the present disclosure. In addition, it will be appreciated that the objects and advantages of the present disclosure may be realized by the means indicated in the claims and combinations thereof.

One embodiment of the present disclosure is directed to providing a signal transmission device and method for modulating two different types of information based on M-FSK and OFDM, respectively, mixing the modulated information into one waveform, and then transmitting the one waveform to one communication channel including a LED light source.

Another embodiment of the present disclosure is directed to providing a signal reception device and method for receiving, through a rolling camera, a signal generated by modulating two different types of information based on M-FSK (or C-OOK) and OFDM, respectively, and then mixing the modulated information into one waveform.

An embodiment of the present disclosure provides an optical communication method using deep learning in a code-division multiple access (CDMA) scheme, performed by a first user device. The method includes obtaining an image of an optical signal from a light source of an optical communication transmission device using a high-resolution camera, applying a first model trained to identify a location of the light source for optical communication in the image to detect the light source in the image, detecting a preamble of an on-off keying (OOK) modulated signal from a pulse signal generated based on the identified light source using a second model trained to detect preambles in received signals and decoding the OOK modulated signal for the first user device by applying a first pseudo-random noise (PN) code assigned to the first user device, and determining a start position of a orthogonal frequency division multiplexing (OFDM) frame in an OFDM modulated signal from the pulse signal generated based on the identified light source using the second model and decoding the OFDM modulated signal for the first user device by applying a first Walsh code assigned to the first user device.

In another embodiment of the present disclosure, the optical signal from the light source of the optical communication transmission device is generated by mixing OOK modulated signals and OFDM modulated signals. The OOK modulated signal is generated by combining a first spread signal, created by applying a first PN code to low-capacity data for a first user device, with a second spread signal, created by applying a second PN code to low-capacity data for a second user device. The OFDM modulated signal is generated by combining a first Walsh-coded signal, created by applying a first Walsh code to high-capacity data for the first user device, with a second Walsh-coded signal, created by applying a second Walsh code to high-capacity data for the second user device.

In another embodiment of the present disclosure, the OOK modulated signal may be a signal modulated using the Camera On-Off Keying (C-OOK) method.

In another embodiment of the present disclosure, the detecting a preamble of an on-off keying (OOK) modulated signal and decoding the OOK modulated signal include detecting the preamble of the OOK modulated signal using the second model, applying the first PN code to the OOK modulated signal based on the detected preamble, and deriving the low-capacity data from the OOK modulated signal according to the C-OOK method.

In another embodiment of the present disclosure, the determining a start position of a orthogonal frequency division multiplexing (OFDM) frame and decoding the OFDM modulated signal include determining the start position of the OFDM frame in the OFDM modulated signal from the pulse signal using the second model, performing a Fast Fourier Transform (FFT) on the pulse signal based on the OFDM frame start position, and applying the first Walsh code to the signal derived from the FFT based on the OFDM frame start position to extract the high-capacity data from the OFDM modulated signal.

In another embodiment of the present disclosure, the second model is a supervised learning-based model generated through training data. The input of the model is an optical signal, and the output includes the preamble start position for applying the first PN code and phase information of the first PN code. The training data includes optical signals generated by combining spread signals created by applying different PN codes to multiple data signals. The training data is labeled with phase information for synchronizing the preamble start position with the PN code.

In another embodiment of the present disclosure, the step of deriving the first low-capacity data includes decoding the OOK modulated signal using a third model trained to decode signals modulated according to the OOK method. The third model is a supervised learning-based model generated through training data, where the input is a data signal modulated according to the OOK method, and the output is the data signal before modulation. The training data includes modulated signals created by applying the OOK method to multiple data signals, with the original data signals labeled as part of the training dataset.

In another embodiment of the present disclosure, the optical communication reception device includes a high-resolution camera for obtaining an image of the optical signal from the light source of the optical communication transmission device, and a processor for processing the images received from the high-resolution camera. The processor applies a first model trained to identify the location of the light source for optical communication in the image to detect the light source in the image, detects the preamble of the OOK modulated signal from the pulse signal generated based on the identified light source using a second model trained to detect preambles and decodes the OOK modulated signal for the optical communication reception device by applying a first PN code assigned to the device, and determines the start position of the OFDM frame in the OFDM modulated signal from the pulse signal using the second model and decodes the OFDM modulated signal for the optical communication reception device by applying a first Walsh code assigned to the device.

Additionally, other methods, systems, and computer-readable storage media storing programs for implementing the disclosed methods may also be provided.

The optical communication system of an embodiment of the present disclosure can receive optical signals that simultaneously transmit high-speed or high-capacity and low-speed or low-capacity data in visible light communication.

In another embodiment of the present disclosure, the optical communication system can receive optical signals that simultaneously transmit different types of data using pulse wave signals and OFDM modulated signals modulated through visible light communication technology.

In another embodiment of the present disclosure, the optical communication system can receive optical signals that simultaneously deliver data for each of multiple user devices.

In another embodiment of the present disclosure, the optical communication system can determine the preamble position and the start point of the OFDM frame to achieve more accurate reception of optical signals when simultaneously transmitting different types of data using modulated pulse wave signals and OFDM modulated signals.

The effects of the present disclosure are not limited to those mentioned above, and other effects not described may be clearly understood by those skilled in the art from the following descriptions.

Other aspects, features, and advantages of the present disclosure will become apparent from the accompanying drawings, claims, and detailed descriptions.

### BRIEF DESCRIPTION OF THE DRAWINGS

FIG. 1 is a diagram schematically illustrating the communication environment of an optical communication transmission device and an optical communication reception device according to an embodiment of the present disclosure.

FIG. 2 is a diagram schematically illustrating the modulation process of a data signal according to an embodiment of the present disclosure.

FIG. 3 is a diagram schematically illustrating an optical communication transmission device and an optical communication reception device in an optical communication system according to an embodiment of the present disclosure.

FIG. 4 is a flowchart illustrating a method for receiving optical signals according to an embodiment of the present disclosure.

FIG. 5 is a diagram illustrating a deep learning model for preamble detection and OOK decoding in the optical communication reception method according to an embodiment of the present disclosure.

FIG. 6A shows a C-OOK signal with a low SNR value according to an embodiment of the present disclosure.

FIG. 6B shows a C-OOK signal with a high SNR value according to an embodiment of the present disclosure.

FIG. 7 is a diagram illustrating the convolution result between a CDMA signal and a preamble pattern according to an embodiment of the present disclosure.

### DETAILED DESCRIPTION

The embodiments disclosed in the present specification will be described in greater detail with reference to the accompanying drawings, and throughout the accompanying drawings, the same reference numerals are used to designate the same or similar components and redundant descriptions thereof are omitted. In the following description, the suffixes “module” and “unit” that are mentioned with respect to the elements used in the present description are merely used individually or in combination for the purpose of simplifying the description of the present disclosure, and therefore, the suffix itself will not be used to differentiate the significance or function or the corresponding term. Further, in the description of the embodiments of the present disclosure, when it is determined that the detailed description of the related art would obscure the gist of the present disclosure, the description thereof will be omitted. Also, the accompanying drawings are provided only to facilitate understanding of the embodiments disclosed in the present disclosure and therefore should not be construed as being limiting in any way. It should be understood that all modifications, equivalents, and replacements which are not exemplified herein but are still within the spirit and scope of the present disclosure are to be construed as being included in the present disclosure.

The terms such as “first,” “second,” and other numerical terms may be used herein only to describe various elements, but these elements should not be limited by these terms. Furthermore, these terms such as “first,” “second,” and other numerical terms, are used only to distinguish one element from another element.

It will be understood that when an element is referred to as being “connected”, “attached”, or “coupled” to another element, it may be directly connected, attached, or coupled to the other element, or intervening elements may be present. In contrast, when an element is referred to as being “directly connected”, “directly attached”, or “directly coupled” to another element, no intervening elements are present.

In the On-Off Keying (OOK) technique, an LED is repeatedly turned on and off, and symbols can be differentiated based on pulse width. Wider pulses represent a logical high (‘1’), while narrower pulses represent a logical low (‘0’). Since data is encoded using pulse width, the transmitted information can affect the dimming level if not calibrated. For instance, a bitstream with multiple ‘1's will appear brighter than a bitstream with multiple ‘0's.

To address this issue, modulation may require the insertion of compensation pulses into the data to equalize overall brightness as needed. The absence of such compensation symbols can cause undesirable and perceivable flickering. Camera On-Off Keying (C-OOK) is one of undersampled modulation schemes, based on OOK scheme. C-OOK can be designed to support a wide range of rolling shutter cameras with limited shutter speeds.

Orthogonal Frequency Division Multiplexing (OFDM) is a modulation method that encodes digital data at multiple carrier frequencies. As a technology having importance in high-speed communication, it divides the bandwidth into orthogonal subcarriers to eliminate distortion caused by inter-symbol interference (ISI). By using Fourier transform methods, the sub-carriers of the OFDM systems can overlap each other without degrading signal performance. Additionally, cyclic prefixes are added to OFDM symbols to mitigate distortion.

The present disclosure proposes a novel hybrid waveform that combines C-OOK and rolling-OFDM for Optical Camera Communication (OCC) systems. Using rolling-OFDM, high-frequency components can be allocated to high-speed streams, while low-frequency components are used for low-speed streams. The hybrid waveform allows a single LED to transmit two data streams simultaneously. By incorporating CDMA and laser concepts, the system improves performance in long-range and multi-user environments. On the receiver side, a single camera can capture both signals.

For accurate optical communication, it is crucial to precisely identify the start of a frame in the hybrid waveform. While zero-crossing techniques work well in high signal-to-noise ratio (SNR) conditions, decoding data can be challenging in low SNR or dynamic environments. The present disclosure proposes using deep learning to decode and detect frame starts in hybrid signals.

Furthermore, the present disclosure describes using a deep learning model to identify the preamble location in OOK modulated signals. This information is then used to determine the start of the OFDM frame in OFDM modulated signals, enabling accurate decoding of both OOK and OFDM signals.

The present disclosure introduces the concept of CDMA into traditional OCC systems and utilizes deep learning to enhance performance when communicating data to multiple users.

The optical communication system described in the embodiments of the present disclosure can generate multiple transmission waveforms for multiple users using a single LED. By incorporating the CDMA (Code-Division Multiple Access) concept, the system improves the throughput of OCC systems.

The optical communication system according to the embodiments of the present disclosure may process data at a lower cost compared to conventional OCC systems.

It should be noted that the term “optical signal” as used herein refers not only to signals composed of light being turned on and off but also to pulse signals used to generate such optical signals.

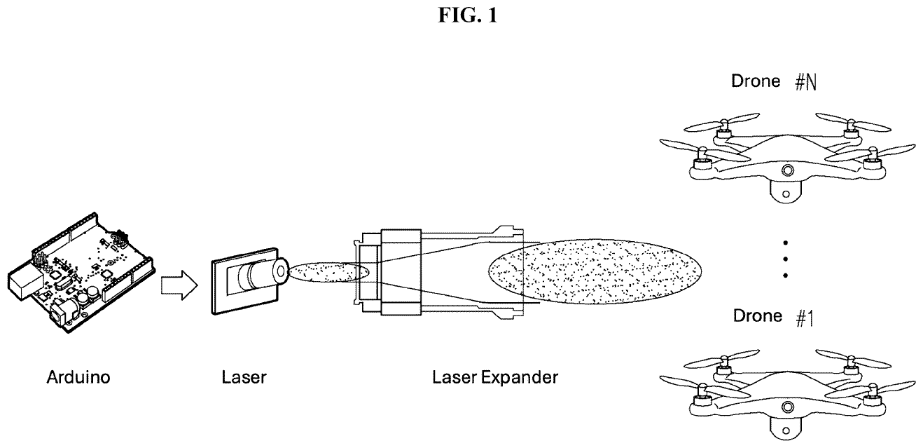

FIG. 1 is a diagram schematically illustrating the communication environment of an optical communication transmission device and an optical communication reception device according to an embodiment of the present disclosure.

The optical communication transmission device in FIG. 1, which includes an Arduino, a laser, and a laser expander, may further include a memory and at least one processor connected to the memory. The processor may be configured to perform the methods described below when executing commands stored in the memory.

The memory is operably connected to the processor and may store at least one code related to the operations performed by the processor. Additionally, the memory may function to store data processed by the processor temporarily or permanently. The memory may include magnetic storage media or flash storage media, but the scope of the present disclosure is not limited thereto.

Such memory may include internal memory and/or external memory, such as volatile memory like DRAM, SRAM, or SDRAM, or non-volatile memory such as OTPROM (one-time programmable ROM), PROM, EPROM, EEPROM, mask ROM, flash ROM, NAND flash memory, or NOR flash memory. It may also include storage devices such as SSDs, compact flash (CF) cards, SD cards, micro-SD cards, mini-SD cards, XD cards, memory sticks, or HDDs.

The processor may include any type of device capable of processing data. The term “processor” as used here refers to a hardware-based data processing device with a physically structured circuit to perform functions represented by codes or instructions within a program. Examples of such hardware-based data processing devices include, but are not limited to, microprocessors, central processing units (CPUs), processor cores, multiprocessors, application-specific integrated circuits (ASICs), field-programmable gate arrays (FPGAs), and graphic processing units (GPUs). The scope of the present disclosure is not limited to these examples.

FIG. 1 illustrates a case of performing laser-CDMA communication using the HOOK (Hybrid On-Off Keying)-OFDM method. A mixed optical signal comprising OOK modulated signals and OFDM modulated signals for respective reception devices can be generated through a microcontroller such as an Arduino.

The signal generated by the optical signal generation device can be transmitted via lasers and laser beam expanders. The optical signal transmitted through lasers and laser beam expanders can cover long distances, and optical signals generated using the CDMA method can be delivered to multiple reception devices.

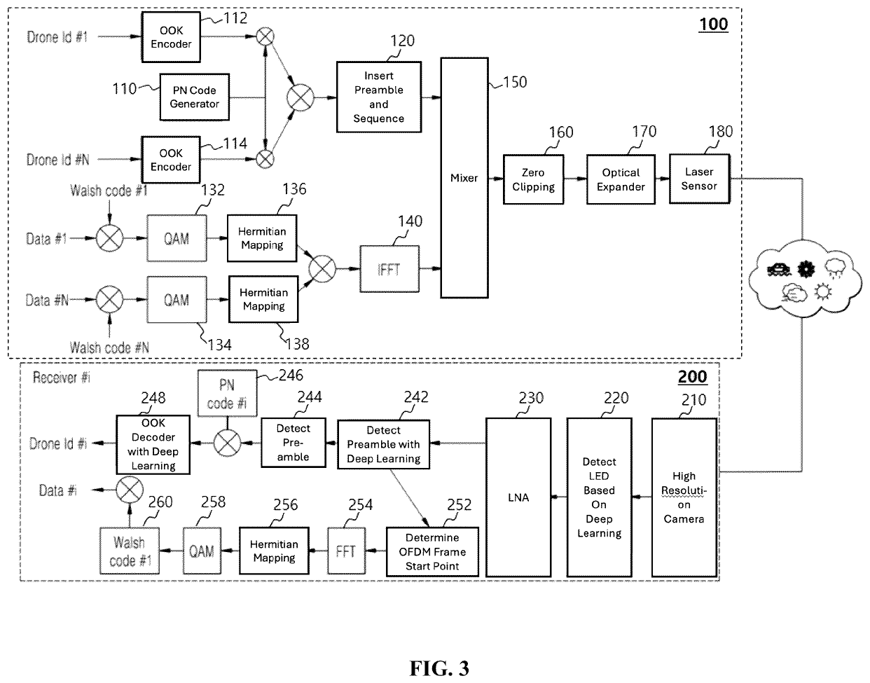

An optical communication transmission device comprising an Arduino, laser, and laser beam expander can generate a single optical signal containing different data for multiple drones using CDMA technology. While multiple drones receive the same optical signal, each drone can properly decode its intended data by utilizing the PN code and/or Walsh code assigned to it. The process of generating optical signals via CDMA will be described in more detail with FIG. 3.

Multiple drones (#1 through #N) that receive optical signals can each be equipped with a camera. Each drone receives the same optical signal through its camera but can decode the data intended for the corresponding drone via CDMA demodulation.

The optical communication method described in the present disclosure can also be applied to systems using LEDs instead of lasers and to other communication terminals besides drones.

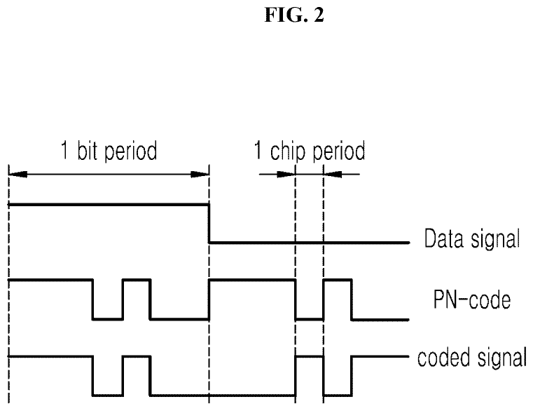

FIG. 2 schematically illustrates the modulation process of data signals according to an embodiment of the present disclosure.

CDMA technology can be utilized to simultaneously transmit different data to multiple recipients. In CDMA, a PN code associated with the target reception device can be applied to the data signal to be transmitted. The optical communication transmission device encodes the signal with a PN code, combines it with other signals encoded with different PN codes for other devices, and transmits the composite signal to the reception devices. At the reception end, each device decodes the data signal intended for it using the PN code assigned to it.

As shown in FIG. 2, a coded signal can be generated by applying a PN code to a data signal. One bit period represents the time required to transmit a single bit of data in the data signal, while the chip period is the smallest unit of the spreading code used in spread-spectrum communication technologies such as CDMA.

FIG. 3 schematically illustrates an optical communication transmission device and an optical communication reception device in an optical communication system according to an embodiment of the present disclosure.

The optical communication system may include an optical communication transmission device (100) and an optical communication reception device (200).

The optical communication transmission device (100) may receive low-capacity data, such as drone IDs (Drone ID #1, . . . . Drone ID #N), and high-capacity data, such as data streams (Data #1, . . . . Data #N). Drone IDs are examples of low-capacity or low-speed data and could represent other types of small-sized data. High-capacity or high-speed data may include drone operational information, images, or audio. The terms “low-capacity” and “high-capacity” refer to relative data size. The upper portion of the optical communication transmission device (100) in FIG. 3 shows a method for modulating low-capacity data using OOK modulation, while the lower portion shows a method for modulating high-capacity data using frequency modulation techniques such as OFDM.

Meanwhile, the OOK modulated signal can be modulated according to the C-OOK (Camera On-Off Keying) method.

The data input into the optical communication transmission device (100) can either be received from external sources or retrieved from the storage of the optical communication transmission device (100).

In the part where data is modulated using the OOK method, the optical communication transmission device (100) may receive low-capacity data such as the first drone ID (Drone ID #1) for a first drone (or first user device) and the N-th drone ID (Drone ID #N) for an N-th drone (or N-th user device, where N is a natural number).

A PN code generator (110) generates PN codes for each drone. An OOK encoder (112, 114) encodes the input drone IDs using the OOK method. Corresponding PN code is applied to each encoded drone ID data. The encoded drone ID data on which PN code are applied to are then combined, and preambles and sequence numbers are added to the composite data by a preamble and sequence number inserter (120).

The PN code generator (110) of the optical communication transmission device (100) can generate different PN codes for data signals intended for different reception devices. For instance, a first PN code may be applied to the data signal for the first user device, and a second PN code may be applied to the data signal for the second user device.

The first and second PN codes may have sufficiently low cross-correlation to ensure that the data signals do not interfere when decoded. In some embodiments, the PN codes may have complete orthogonality. The generation and application of PN codes, as well as the merging of the resulting spread signals, follow CDMA technology principles.

The processor of the optical communication transmission device (100) may apply the first PN code to the first data signal to generate a first spread signal and the second PN code to the second data signal to generate a second spread signal.

The first and second spread signals can be combined, and preambles and sequence numbers can be added thereafter.

For high-capacity data modulated using the OFDM method, the optical transmission device (100) may receive the first data (Data #1) for the first drone and the N-th data (Data #N) for the N-th drone. The processor of the optical communication transmission device (100) may apply a Walsh code assigned to each drone to each data.

Data encoded with Walsh codes is modulated via QAM (Quadrature Amplitude Modulation; 132, 134) and transformed using Hermitian mapping (136, 138). The transformed data streams are then combined, and IFFT (Inverse Fast Fourier Transform) is applied to the composite data.

Signals generated through the OOK method and those generated through the OFDM method are mixed together in a mixer (150), pass through zero-clipping (160), and are transmitted as optical signals via an optical amplifier (170) and laser sensor (180).

The transmitted optical signal from the optical communication transmission device (100) may contain low-capacity data, such as drone IDs, and high-capacity data, such as drone operational information, for drone #1 through drone #N.

The optical signal is delivered to the optical communication reception device (200) under various optical environments.

The optical communication reception device (200) uses a high-resolution camera (210) to capture images of the optical signal transmitted from the optical communication transmission device (100).

The optical signal from the light source of the optical communication transmission device (100) can be generated by mixing OOK modulated signals and OFDM modulated signals. The OOK modulated signal may be created by combining a first spread signal, generated by applying a first PN code to low-capacity data for the first drone, with an N-th spread signal, generated by applying an N-th PN code to low-capacity data for the N-th drone.

The OFDM modulated signal may be generated by combining a first Walsh-coded signal, created by applying a first Walsh code to the first high-capacity data for the first drone, with an N-th Walsh-coded signal, created by applying an N-th Walsh code to N-th high-capacity data for the N-th drone.

The optical communication reception device (200) may utilize a first deep learning model (220) to identify the position of a light source (e.g., an LED). The first deep learning model (220) can be a trained model designed to identify the location of the light source for optical communication within the captured image.

The first deep learning model (220) may be a supervised learning-based model trained with labeled images where the light source related to the optical signal is marked. This model accurately detects the position of the light source in the received images. The input to the model is the images captured by the camera, and the output is the identified region of the light source for optical communication within the images.

Based on the identified light source, the extracted signal may be a pulse signal. The pulse signal extracted from the identified light source region of the image passes through a Low Noise Amplifier (LNA; 230) for signal amplification. To detect the preamble in the amplified signal, a second deep learning model (242) may be used. The second deep learning model (242) is a pre-trained model designed to detect preambles in received signals.

The training data for the preamble detection model (the second deep learning model) may include optical signals generated by mixing spread signals created by applying different PN codes to multiple data signals. The training data is labeled with phase information for synchronizing the preamble's starting position with the PN code.

The second deep learning model (242) is a supervised learning-based model trained with input data including optical signals or pulse signals corresponding to them, and output data including the preamble's starting position and/or the phase information of the first PN code, which may provide reference points to apply the first PN code.

Using the second deep learning model (242) trained to detect preamble of a received signal, the preamble of the OOK modulated signals, which are combined for multiple drones, can be detected from the pulse signal. Based on the detected preamble, the first PN code assigned to the first drone (first user device) can be applied, and synchronization for applying the first PN code can be properly established.

The preamble detected by the second deep learning model (242) can also be used to determine the start position of the OFDM frame in the OFDM modulated signal. The OFDM frame start position detector (252) utilizes the preamble detected by the second deep learning model (242) to identify the start position of the OFDM frame in the OFDM modulated signal. Accurately determining the start position of the OFDM modulated signal is necessary for proper demodulation of the OFDM modulated signal.

The processor of the optical communication reception device (200) determines the start position of the OFDM frame in the OFDM modulated signal combined for multiple user devices using the second deep learning model for the pulse signal. Based on the OFDM frame start position, the processor performs an FFT (Fast Fourier Transform; 254) on the pulse signal. After applying Hermitian mapping (256) and QAM (258), the processor applies the first Walsh code assigned to the first drone to demodulate the OFDM modulated signal for the first drone, extracting the high-capacity data for the first drone.

In the step of demodulating the OOK modulated signal, the processor of the optical communication reception device (200) detects the preamble of the OOK modulated signal using the second deep learning model. Based on the detected preamble, the processor applies the first PN code to the OOK modulated signal and extracts the first low-capacity data for the first drone from the OOK modulated signal using the C-OOK method.

To decode the OOK modulated signal, the processor applies an OOK decoder (248) to the signal, which has been demodulated with the first PN code. The OOK decoder may be a deep learning-based decoder capable of decoding the OOK modulated signal. The third deep learning model for OOK decoding is a model trained to demodulate signals modulated using the OOK method. By using the third deep learning model, the OOK modulated signal can be demodulated to extract low-capacity data intended for the first drone.

The third deep learning model, trained for OOK decoding, may be a supervised learning-based model. The input to this model is data signals modulated via the OOK method, while the output includes the original data signals before modulation. The training data may include multiple data signals modulated using the OOK method, with the original data signals labeled as part of the training set.

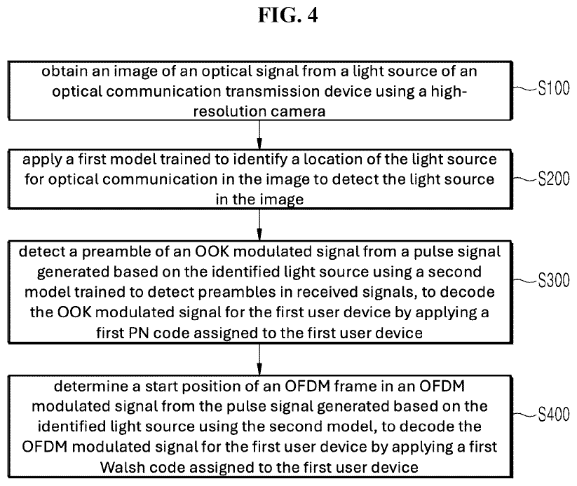

FIG. 4 is a flowchart illustrating a method for receiving optical signals according to an embodiment of the present disclosure.

The flowchart in FIG. 4 depicts a method for receiving optical signals that can be performed by the processor of each user device. The processor obtains images of the optical signals transmitted from the light source of the optical communication transmission device (100) using a high-resolution camera equipped in the optical communication reception device (200) (S100).

The processor of the optical communication reception device (200) applies the first deep learning model trained to identify the position of the light source for optical communication to detect the light source in the captured image (S200).

To efficiently allocate processing resources, the first deep learning model narrows down the region of interest to areas where the light source for optical communication exists, rather than processing the entire image captured by the high-resolution camera.

The processor then applies the second deep learning model, trained to detect preambles in received signals, to the pulse signal generated from the narrowed-down region. The processor detects the preamble of the low-frequency modulated signal or modulated low-capacity data and applies the first PN code assigned to the first user device.

Here, the low-frequency modulated signal refers to the OOK modulated signal combined for multiple user devices using the CDMA method.

Based on the detected preamble of the low-frequency modulated signal, the processor performs synchronization and applies the first PN code to decode the first low-capacity data for the first user device. By this, the processor can decode the first low-capacity data for the first user device.

The processor of the optical communication reception device (200) determines the start position of the OFDM frame of the OFDM modulated signal in the pulse signal, which is generated based on the identified light source, using the second deep learning model.

The processor then demodulates the OFDM modulated signal for the first user device by applying the first Walsh code assigned to the first user device, based on the determined OFDM frame start position. The processor subsequently decodes the high-capacity data intended for the first user device.

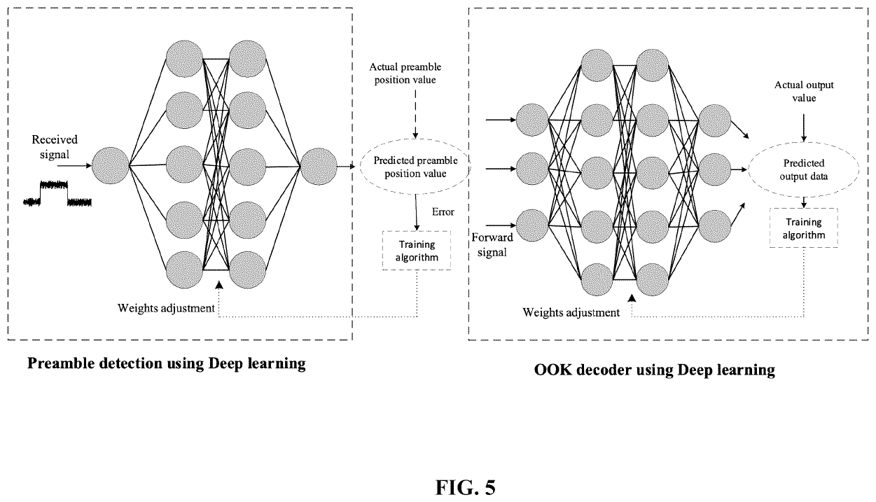

FIG. 5 is a diagram illustrating the deep learning model used for preamble detection and OOK decoding in the optical signal reception method according to an embodiment of present disclosure.

On the left side of FIG. 5, a deep learning model for predicting preamble positions is shown, while on the right side, a model for predicting output data based on the detected preamble positions is depicted.

The deep learning model for predicting preamble positions takes as input a signal containing a preamble and is trained using labeled data where the actual position of the preamble is provided as the label. This model uses supervised learning techniques.

The model for predicting output data based on preamble positions uses the preamble position as input and the actual output data as labeled training data to predict the corresponding output data.

The processor uses these two models to predict the preamble in the received signal and decode the original signal based on the predicted preamble.

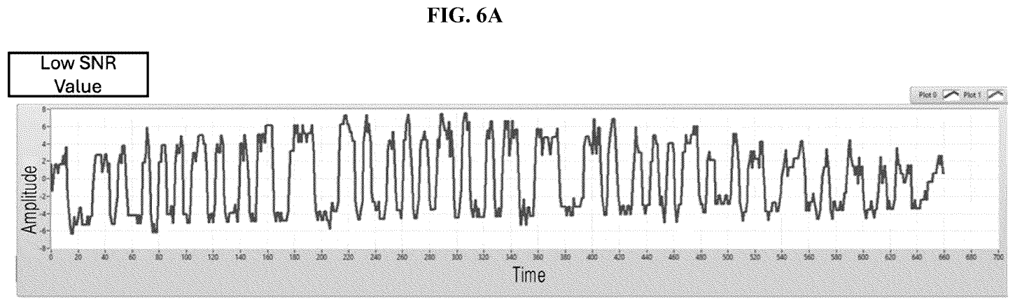

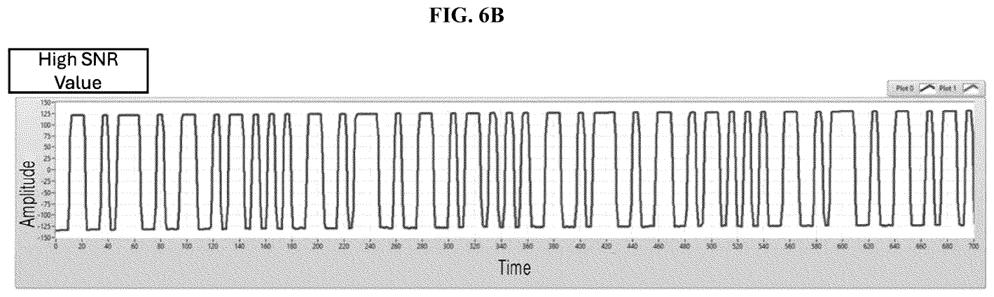

FIG. 6A shows a C-OOK signal with a low SNR value according to an embodiment of the present disclosure. FIG. 6B shows a C-OOK signal with a high SNR value according to an embodiment of the present disclosure.

Depending on the SNR value, the C-OOK signal exhibits different characteristics, which can be utilized when generating training data to train a model for preamble detection.

For example, multiple training data sets can be created by applying various SNR values to a single OOK modulated signal. This approach allows for generating a large amount of training data at low cost.

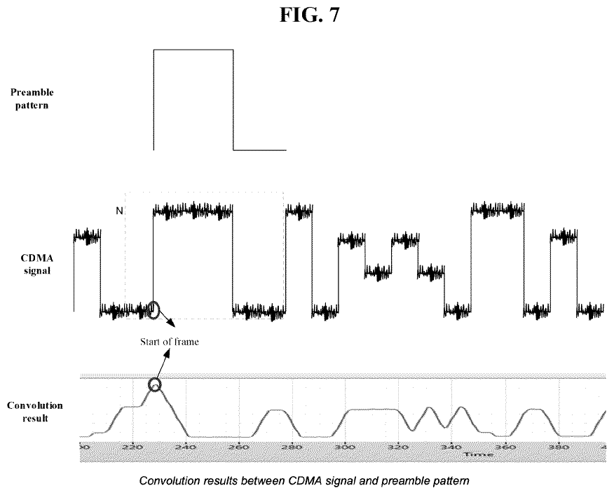

FIG. 7 is a diagram illustrating the convolution results between a CDMA signal and a preamble pattern according to an embodiment of the present disclosure.

The signals generated by the optical communication transmission device (100), as described above, may include preamble patterns such as those shown in FIG. 7. Optical signals generated by the optical communication transmission device (100) using the CDMA method may include signals combined for multiple users. As shown in FIG. 7, these may be mixed signals comprising OOK modulated and OFDM modulated signals.

Using the second deep learning model, the preamble position and pattern in the CDMA signal can be detected. When the convolution is performed between the detected preamble pattern and the CDMA signal, the processor can identify the start of the OFDM frame in the CDMA signal.

Accordingly, the processor of the optical communication reception device (200) in an embodiment of the present disclosure can accurately detect the preamble of the OOK modulated signal and identify the start of the OFDM frame in the OFDM modulated signal using the model designed for preamble detection.

The present disclosure described above may be implemented as a computer-readable code in a medium on which a program is written. The computer readable medium includes all types of recording devices in which data readable by a computer system may be stored. Examples of the computer readable medium, a hard disk drive (HDD), a solid state disk (SSD), a silicon disk drive (SDD), a read-only memory (ROM), a random-access memory (RAM), CD-ROM, a magnetic tape, a floppy disk, an optical data storage device, and the like. Moreover, the computer may include a processor of the signal transmission device or the signal reception device.

Meanwhile, the computer programs may be those specially designed and constructed for the purposes of the present disclosure or they may be of the kind well known and available to those skilled in the computer software arts. Examples of program code include both machine code, such as produced by a compiler, and higher level code that may be executed by the computer using an interpreter.

As used in the present application (especially in the appended claims), the terms ‘a/an’ and ‘the’ include both singular and plural references, unless the context clearly states otherwise. Also, it should be understood that any numerical range recited herein is intended to include all sub-ranges subsumed therein (unless expressly indicated otherwise) and therefore, the disclosed numeral ranges include every individual value between the minimum and maximum values of the numeral ranges.

The order of individual steps in process claims of the present disclosure does not imply that the steps must be performed in this order; rather, the steps may be performed in any suitable order, unless expressly indicated otherwise. In other words, the present disclosure is not necessarily limited to the order in which the individual steps are recited. All examples described herein or the terms indicative thereof (“for example”, etc.) used herein are merely to describe the present disclosure in greater detail. Therefore, it should be understood that the scope of the present disclosure is not limited to the example embodiment described above or by the use of such terms unless limited by the appended claims. Also, it should be apparent to those skilled in the art that various alterations, substitutions, and modifications may be made within the scope of the appended claims or equivalents thereof. It should be apparent to those skilled in the art that various substitutions, changes and modifications which are not exemplified herein but are still within the spirit and scope of the present disclosure may be made.

Therefore, the present disclosure is thus not limited to the example embodiments described above, and rather intended to include the following appended claims, and all modifications, equivalents, and alternatives falling within the spirit and scope of the following claims.

What is claimed is:

1. An optical communication method using deep learning in a code-division multiple access (CDMA) scheme, performed by a first user device, comprising:
obtaining an image of an optical signal from a light source of an optical communication transmission device using a high-resolution camera;
applying a first model trained to identify a location of the light source for optical communication in the image to detect the light source in the image;
detecting a preamble of an on-off keying (OOK) modulated signal from a pulse signal generated based on the identified light source using a second model trained to detect preambles in received signals, to decode the OOK modulated signal for the first user device by applying a first pseudo-random noise (PN) code assigned to the first user device; and
determining a start position of an orthogonal frequency division multiplexing (OFDM) frame in an OFDM modulated signal from the pulse signal generated based on the identified light source using the second model, to decode the OFDM modulated signal for the first user device by applying a first Walsh code assigned to the first user device.

2. The optical communication method of claim 1, wherein an optical signal from the light source of the optical communication transmission device is generated by mixing the OOK modulated signals and the OFDM modulated signals,
wherein the OOK modulated signal is generated by combining the first spread signal, created by applying a first PN code to a first low-capacity data for the first user device, with a second spread signal, created by applying a second PN code to a second low-capacity data for a second user device, and
wherein the OFDM modulated signal is generated by combining a first Walsh-coded signal, created by applying a first Walsh code to a first high-capacity data for the first user device, with a second Walsh-coded signal, created by applying a second Walsh code to a second high-capacity data for the second user device.

3. The optical communication method of claim 2, wherein the OOK modulated signal is modulated using the Camera On-Off Keying (C-OOK) method.

4. The optical communication method of claim 3, wherein detecting the preamble of the OOK modulated signal comprises:
detecting the preamble of the OOK modulated signal using the second model;
applying the first PN code to the OOK modulated signal based on the detected preamble; and
deriving the first low-capacity data from the OOK modulated signal according to the C-OOK method.

5. The optical communication method of claim 2, wherein determining the start position of the OFDM frame comprises:
determining the start position of the OFDM frame in the OFDM modulated signal from the pulse signal using the second model;
performing a Fast Fourier Transform (FFT) on the pulse signal based on the OFDM frame start position; and
applying the first Walsh code to a signal derived from the FFT based on the start position of the OFDM frame start to extract the first high-capacity data from the OFDM modulated signal.

6. The optical communication method of claim 2, wherein the second model is a supervised learning-based model generated through training data,
wherein an input of the second model is an optical signal, and an output of the second model is a preamble start position for applying the first PN code and phase information of the first PN code,
wherein the training data includes optical signals generated by combining spread signals created by applying different PN codes to multiple data signals respectively, and
wherein the training data is labeled with phase information for synchronizing the preamble start position with the PN codes.

7. The optical communication method of claim 4, wherein deriving the first low-capacity data includes:
demodulating the OOK modulated signal using a third model trained to demodulate signals modulated according to the OOK method to derive the first low-capacity data,
wherein the third model is a supervised learning-based model generated through training data, wherein an input of the third model is a data signal modulated according to the OOK method, and an output of the third model is the data signal before modulation, and
wherein the training data includes modulated signals created by applying the OOK method to multiple data signals, labeled with original data signals before modulation.

8. An optical communication reception device using deep learning in a code-division multiple access (CDMA) scheme, comprising:
a high-resolution camera configured to obtain an image of the optical signal from a light source of an optical communication transmission device, and a processor configured to process the image received from the high-resolution camera,
the processor further configured to:
apply a first model trained to identify location of the light source for optical communication in the image to detect the light source in the image; detect a preamble of an OOK modulated signal from a pulse signal generated based on the identified light source using a second model trained to detect preambles and decodes the OOK modulated signal for the optical communication reception device by applying a first PN code assigned to the optical communication reception device; and
determine a start position of an OFDM frame in an OFDM modulated signal from the pulse signal using the second model to decode the OFDM modulated signal for the optical communication reception device by applying a first Walsh code assigned to the optical communication reception device.

9. The optical communication reception device of claim 8, wherein an optical signal from the light source of the optical communication transmission device is configured to be generated by mixing the OOK modulated signals and the OFDM modulated signals,
wherein the OOK modulated signal is configured to be generated by combining the first spread signal, created by applying a first PN code to a first low-capacity data for the first user device, with a second spread signal, created by applying a second PN code to a second low-capacity data for a second user device,
wherein the OFDM modulated signal is configured to be generated by combining a first Walsh-coded signal, created by applying a first Walsh code to a first high-capacity data for the first user device, with a second Walsh-coded signal, created by applying a second Walsh code to a second high-capacity data for the second user device.

10. The optical communication reception device of claim 9, wherein the OOK modulated signal is configured to be modulated using the Camera On-Off Keying (C-OOK) method.

11. The optical communication reception device of claim 10, wherein to detect a preamble of an on-off keying (OOK) modulated signal, the processor is configured to:
detect the preamble of the OOK modulated signal using the second model;
apply the first PN code to the OOK modulated signal based on the detected preamble; and
derive the first low-capacity data from the OOK modulated signal according to the C-OOK method.

12. The optical communication reception device of claim 9, wherein to determine the start position of the OFDM frame, the processor is configured to:
determine the start position of the OFDM frame in the OFDM modulated signal from the pulse signal using the second model;
perform a Fast Fourier Transform (FFT) on the pulse signal based on the OFDM frame start position; and
apply the first Walsh code to a signal derived from the FFT based on the start position of the OFDM frame start to extract the first high-capacity data from the OFDM modulated signal.

13. The optical communication reception device of claim 9, wherein the second model is a supervised learning-based model generated through training data,
wherein an input of the second model is an optical signal, and an output of the second model is a preamble start position for applying the first PN code and phase information of the first PN code,
wherein the training data includes optical signals generated by combining spread signals created by applying different PN codes to multiple data signals respectively, and
wherein the training data is labeled with phase information for synchronizing the preamble start position with the PN codes.

14. The optical communication reception device of claim 11, wherein to derive the first low-capacity data, the processor is configured to:
demodulate the OOK modulated signal using a third model trained to demodulate signals modulated according to the OOK method to derive the first low-capacity data, and
wherein the third model is a supervised learning-based model generated through training data, wherein an input of the third model is a data signal modulated according to the OOK method, and an output of the third model is the data signal before modulation, and
wherein the training data includes modulated signals created by applying the OOK method to multiple data signals, labeled with original data signals before modulation.
